(19) United States
(12) Patent Application Publication
(10) Pub. No.: US 2023/0356318 A1
(43) Pub. Date: Nov. 9, 2023

(54) PILASTER MOUNTING STUD FOR KEYHOLE

(71) Applicant: Mitchell James Fontaine, San Bruno, CA (US)

(72) Inventor: Mitchell James Fontaine, San Bruno, CA (US)

(21) Appl. No.: 16/740,618

(22) Filed: Jan. 13, 2020

(51) Int. Cl. B23K 11/00

(52) U.S. Cl. CPC B23K 11/0053

(57) ABSTRACT

PILASTER MOUNTING STUD FOR KEYHOLE has a predetermined amount of material protruding on one side which is used during a resistance welding process to create a permanent bond between the PILASTER MOUNT STUD FOR KEYHOLE and a sheet metal surface. This allows the PILASTER MOUNT STUD FOR KEYHOLE to have an application of a mounting provision for a load bearing weight.

### BACKGROUND OF INVENTION

The current way pilaster racks for adjustable shelves mount are with rivets holding them to a sheet metal surface. Rivets wear, have tensile failure, shear out, cleavage fracture, rivet shear, tearing of the sheet metal and pullout.

### SUMMARY OF INVENTION

The PILASTER MOUNTING STUD FOR KEYHOLE invention allows a process for securing a mounting provision with a resistance welded process that has a predetermined amount of material on one side of the PILASTER MOUNTING STUD FOR KEYHOLE which welds to a sheet metal surface where the PILASTER MOUNTING STUD FOR KEYHOLE becomes a permanent fixture and is a load bearing mounting provision. PILASTER MOUNTING STUD FOR KEYHOLE is not limited to shelving; it could be used for any reason that a mounting provision or a load bearing application is required.

### DRAWING DESCRIPTIONS

FIG. 1 on sheet 1 is a plan view of PILASTER MOUNTING STUD FOR KEYHOLE.

FIG. 2 on sheet 1 is a sectional view of PILASTER MOUNTING STUD FOR KEYHOLE.

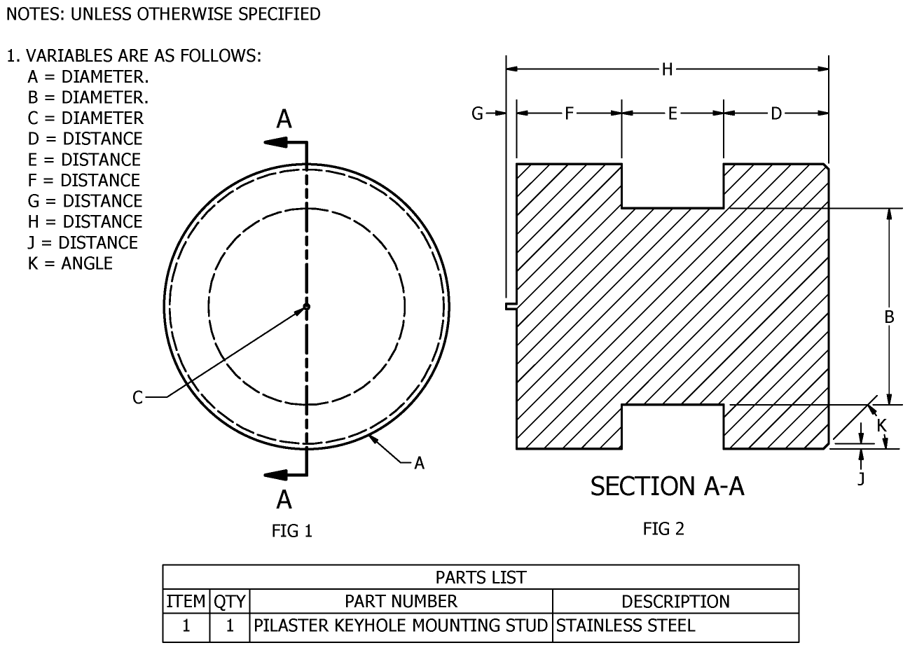

### DETAILED DESCRIPTION

PILASTER MOUNTING STUD FOR KEYHOLE creates a load bearing mounting provision without joining two pieces of metal with a rivet or a fastener, but creates a load bearing mounting provision by resistance welding the PILASTER MOUNTING STUD FOR KEYHOLE. The predetermined amount of material on one side of the PILASTER MOUNTING STUD FOR KEYHOLE is resistance welded to a sheet metal surface where the PILASTER MOUNTING STUD FOR KEYHOLE is permanently secured and allows a load bearing application. The typical rivet joint fails with tensile failure, shear out, cleavage fracture, rivet shear, tearing of the sheet metal and pullout. Since it has two pieces of sheet metal joined together mechanically with a rivet or fastener and a shear load added to it with a shelf or anything that is placed on the shelf will add to the load and increase failure rate. PILASTER MOUNTING STUD FOR KEYHOLE does not weaken the way a typical rivet or fastener application does since it is welded and permanently joined to the sheet metal surface.

1. Is a method of creating a permanent load bearing mounting provision on a sheet metal surface by resistance welding a PILASTER MOUNTING STUD FOR KEYHOLE that has a predetermined amount of material on one side so that it will permanently weld the PILASTER MOUNTING STUD FOR KEYHOLE to the surface of sheet metal.
a) PILASTER MOUNTING STUD FOR KEYHOLE pieces have a predetermined amount of material to create a permanent bond during resistance welding to sheet metal.
b) The permanent welded bond of the PILASTER MOUNTING STUD FOR KEYHOLE allows for mounting provisions that are load bearing.
